(19) United States
(12) Patent Application Publication
(10) Pub. No.: US 2025/0266572 A1
(43) Pub. Date: Aug. 21, 2025

(54) FLEXIBLE LITHIUM-SULFUR BATTERIES

(71) Applicant: LI-S ENERGY LIMITED, Brisbane (AU)

(72) Inventors: Ying Ian CHEN, Geelong (AU); Baozhi YU, Geelong (AU); Ye FAN, Geelong (AU); Tao TAO, Geelong (AU)

(73) Assignee: LI-S ENERGY LIMITED, Brisbane (AU)

(21) Appl. No.: 19/186,927

(22) Filed: Apr. 23, 2025

Related U.S. Application Data
(62) Division of application No. 17/761,647, filed on Mar. 18, 2022.

(30) Foreign Application Priority Data
Sep. 20, 2019 (AU) 2019903509

(51) Int. Cl. H01M 50/417; H01M 10/052; H01M 50/403; H01M 50/491; H01M 50/497

(52) U.S. Cl. CPC H01M 50/417; H01M 10/052; H01M 50/403; H01M 50/491; H01M 50/497

(57) ABSTRACT

High performance flexible lithium-sulfur flexible energy storage devices include a flexible lithium metal anode for an energy storage device comprising an electrically conducting fabric functionalised with a 3D hierarchical MnO₂ nanosheet lithiophilic material; a flexible graphene/sulfur cathode protected by a FBN/G interlayer; and a flexible separator for an energy storage device, wherein the separator comprises one or more microporous films of Li ion selective permeable polyolefin material wherein at least a portion of the pores of the film are associated with nanoporous polysulfone polymer positioned between the anode and the cathode.

### TECHNICAL FIELD

The invention relates to high performance flexible lithium-sulfur batteries and components thereof, particularly, anodes and separators particularly suited for use in a flexible battery.

### BACKGROUND OF INVENTION

Flexible and high-performance batteries are urgently required for powering flexible/wearable electronics, but the current flexible lithium-ion batteries have relatively low energy densities. Lithium-sulfur batteries have a much higher energy density but development of flexible lithium-sulfur batteries remains a formidable challenge.

Lithium-sulfur (Li—S) batteries are considered as a promising alternative that can outperform the current lithium-ion batteries (LIBs) due to their high theoretical energy density, low cost and the natural abundance of environmentally benign sulfur active materials. A flexible Li—S battery must afford stable electrochemical performance when being repeatedly bent, folded, or stretched. All components in a flexible cell, including cathode, anode, separator, electrolyte, and current collectors, have to be mechanically flexible enough to withstand repeated mechanical deformation. Furthermore, maintenance of continuous electron/ion pathways are required to prevent cell failure. Flexible sulfur cathodes including the combination of sulfur with flexible conductive hosts including carbon nanotubes, graphene, carbonized polymers, commercial carbon fibres and their composites are known. In addition, functional interlayers have been developed for the cathodes to reduce the shuttle effects of the polysulfides (PSs). In particular, the thin and selective interlayer of functionalised boron nitride nanosheets/graphene (FBN/G) shows great potential to decrease the charge transfer resistance and mitigate the shuttling problem. However, the improved flexible cathodes alone cannot ensure good performance of flexible Li—S full cells.

Few reports can be found on the research of flexible lithium-based anodes. The major challenge related to the lithium metal anode is poor mechanical flexibility, and thus it is difficult to recover after bending and twisting. A permanent distortion including wrinkling, creasing, or buckling is introduced by local extrusion. In addition, infinite volume change and dendritic growth in the Li anode also strongly affects the cycling life of lithium metal anodes. Recently, two strategies were reported to fabricate flexible lithium anodes, mechanical rolling a lithium foil into a thin film together with flexible materials such as conductive poly(ethylene terephthalate) (PET) and boron nitride/Ti₃C₂ Mxene. Although the hybrid anodes have improved mechanical flexibility, the used flexible materials still have the volume change issue in the anode during Li plating/stripping cycles. Different approaches for developing new flexible anodes are desirable.

Commercial separators for Li—S batteries are designed to prevent direct electron transport without disturbing Lit passage between the anode and cathode. However, large pores in these commercial separators allows not only Li⁺ but also soluble polysulfides to pass, resulting in cell degradation over time. General strategies to improve separators mainly involve covering the separators with additional layers which act as a filter. However, the thickness and weight of additional layers will lead to an increase of total thickness and weight of the full cells and thus a reduction of gravimetric and volumetric energy densities. Furthermore, the flexibility of such separators has not been accessed.

Flexible power sources with high energy density, electrochemical sustainability and light weight are urgently needed because of the increasing usage of Internet of Things and flexible/wearable electronics. Among various new battery systems, lithium-sulfur (Li—S) batteries are considered as a promising alternative that can outperform the current lithium-ion batteries (LIBs) due to their high theoretical energy density, low cost and the natural abundance of environmentally benign sulfur active materials. Flexible and high-performance batteries are urgently required for powering flexible/wearable electronics

To obtain a flexible Li—S full cell with excellent electrochemical and mechanical performance, flexibility of all three components (cathode, anode and separator) must be ensured.

### SUMMARY OF INVENTION

In a first aspect, the invention provides a separator for an energy storage device, wherein the separator comprises one or more porous films of Li ion selective permeable material wherein at least a portion of the pores of the film are associated with a porous sulfur containing polymer, wherein the pores of the sulfur containing polymer are at least one order of magnitude smaller than the pores of the Li ion selective permeable material.

Pores in the film may have different shapes and sizes with a pore diameter which varies from >100 nm up to about 10 micrometres (μm). After filling with the porous sulfur polymer, in one embodiment, the original pore size in the film is substantially reduced to 50 nm or less. Therefore, the average pore size is reduced by an order of 0.5 or greater (a factor of 2 times or greater), more preferably by an order of 0.75 or greater (a factor of 5 times or greater), most preferably by an order of 1 or greater (a factor of 10 times or greater).

In a particularly preferred embodiment, the pores in the sulfur containing polymer are smaller than the pores in the porous films of Li ion selective permeable material by about 1 order of magnitude or greater (a factor of 10 or greater).

In a related aspect, the invention provided a separator for an energy storage device, wherein the separator comprises one or more microporous films of Li ion selective permeable material wherein at least a portion of the micrometer pores of the film are associated with a nanoporous sulfur containing polymer.

Desirably, the sulfur containing polymer has a melting point of 250° C. or greater, more preferably than 275° C. or greater, and most preferably still 280° C. or greater. Preferred sulfur containing polymers are sulfur containing polymers.

Commercially available separators typically comprise films having an average pore size of greater than 100 nm. In the present invention, after functionalisation with sulfur containing polymer, the average pore size is about 10 nm.

Suitably, the film of the separator comprises a microporous polymer. Suitably, the film comprises a micropore porosity of from about 20% to about 70% of the surface area of the film.

Desirably, the sulfur containing polymer is selectively permeable to lithium ions and electrolyte but not to polysulfides. Preferably, the nanoporous sulfur containing polymer has pore diameters range from about 5 nm to about 20 nm. Preferred porosity of the nanoporous sulfur containing polymer ranges from 10% to 30% of the surface area of the film.

In a preferred embodiment, the film thickness ranges from about 10 μm to 50 μm, more preferably from about 20 μm to 35 μm, most preferably from about 25 μm to 28 μm.

In the separator as defined herein, the sulfur containing polymer fills at least a portion of the pores of the film. Filing at least a portion of the pores of the separator film reduces the microporosity of the film better hindering passage of polysulfides through the separator while still allowing lithium ion passage through the separator. More preferably substantially all of the pores in the film are filled with the sulfur containing polymer after functionalisation. It is preferred that the sulfur containing polymer is not present on the surface of the film or is present only in negligible amounts thereon to avoid the separator being heavier and/or thicker than necessary. Restricting the association between the sulfur containing polymer to at least a portion of the pores of the film and not the film surfaces advantageously results in a better separator for excluding polysulfides without a substantial increase in the total thickness and total weight of the separator or an energy storage device including the separator of the invention. This means the separators is more effective at hindering polysulfide passage/shuttling than prior art separators but without the reduced gravimetric and volumetric energy densities observed for prior art separators where polysulfide filtering layers or coatings are added to the separator.

Preferably, the separator of the invention has an ionic conductivity of greater than 6.87 mS cm⁻¹ at 25° C. One exemplified separator has an ionic conductivity of about 6.41 mS cm⁻¹ at 25° C.

Suitably, during manufacture, the micropores of the separator film are filed with the sulfur containing polymer. Then, the sulfur containing polymer provided in the micropores of the film is made nanoporous, preferably via a phase inversion process. It has been found that utilising a phase inversion process readily produced nanopores in the sulfur containing polymer. Inclusion of sulfur containing polymer in this manner also results in better overall thermal and mechanical separator stability.

Preferably, the total amount of the sulfur containing polymer in the film is about 20 wt % or

less, more preferably, 10 wt % or less.

Suitably, the mass loading of the sulfur containing polymer is from about 0.20 mg/cm⁻² to about 0.4 mg/cm⁻², more preferably from about 0.10 mg/cm⁻² to about 0.2 mg/cm⁻².

Most preferably, substantially all pores of the film are filled with the porous sulfur containing polymer, but inclusion of the filler polymer does not increase the total weight of the separator by more than about 10 wt %. Preferably, the sulfur containing polymer is present at about 20 wt % or less, more preferably at about 15 wt % or less, most preferably at about 10 wt % or less.

In a preferred embodiment, the material of the film is different to the sulfur containing polymer which fills the micropores of the film.

In a particularly preferred embodiment, the sulfur containing polymer is a functionalised or unfunctionalised aromatic polysulfone, preferably a polyarylethersulfone (PAES) for example, polysulfone. In some embodiments, a quaternary ammonia polysulfone polymer is less preferred.

In some embodiments, the film is in the form of a laminate of two or more films of the Li ion selective permeable material.

Desirably, the sulfur containing polymer has a melting point of 250° C. or greater, more preferably than 275° C. or greater, and most preferably still 280° C. or greater. Such materials can be advantageously used as a thermal fuse in an energy storage device as at the melting point, the porosity of the film is lost, effectivity shutting down the device.

Desirably, the material of the film comprises an organic polymer, particularly a polyolefin polymer, which may be functionalised or unfunctionalised. Organic polymers being unfunctionalised polyolefins are particularly preferred. Further desirably, the film comprises polyethylene, polypropylene, and combinations thereof.

In a particularly preferred embodiment, the separator of the invention is a flexible separator. The flexibility of the separator will be determined by the film thickness and stiffness. However, manually flexible, manually twistable, and/or manually foldable separators are particularly preferred.

In a particularly preferred embodiment, the thickness of the film is substantially the same after the sulfur containing polymer treatment, e.g., about 26 microns.

Desirably, the wettability of the functionalised film is substantially the as that of the untreated film.

In a second aspect of the invention, there is provided a method of preparing a separator for an energy storage device comprising the steps of:
(i) providing a porous separator for the energy storage device comprising one or more porous films of at least one Li ion selective permeable material;
(ii) forming a sulfur containing polymer functionalised film by filing the pores of the film of at least one Li ion selective permeable material with at least one sulfur containing polymer;
(ii) introducing pores into the sulfur containing polymer, wherein the pores of the sulfur containing polymer are at least one order of magnitude smaller than the pores of the Li ion selective permeable material.

In a related aspect of the invention, there is provided a method of preparing a separator for an energy storage device comprising the steps of:
(i) providing a porous separator for the energy storage device comprising one or more microporous films of at least one Li ion selective permeable material;
(ii) forming a sulfur containing polymer functionalised film by filing the micropores of the film of at least one Li ion selective permeable material with at least one sulfur containing polymer;
(ii) introducing nanopores into the sulfur containing polymer.

Desirably, the step of forming the sulfur containing polymer functionalised film involves proving a solution of the sulfur containing polymer in a solvent to the surface film of at least one Li ion selective permeable material, for example, by solvent casting.

Suitably, the method further comprises adjusting the thickness of the sulfur containing polymer layer to a desired level, preferably about 200 μm. In one embodiment, the application and adjusting steps involve doctor blading. The method further comprises subsequently removing the solvent to form the sulfur containing polymer functionalised film. Suitably, the solvent can be removed by vacuum assisted evaporation.

The method may further comprise removing excess sulfur containing polymer from the film, for example, by wiping or brushing the excess polymer off the surface of the film. It will be understood that this step removes excess sulfur containing polymer which is not in the pores from the separator. In other words, the excess sulfur containing polymer is removed from the polymer surface but not the pores. In one embodiment, the excess sulfur containing polymer is removed from the film surface by vacuum.

Preferably, the thickness of the separator is substantially the same as the thickness prior to introduction of the sulfur containing polymer into the pores of the film.

Preferably, the nanopores are introduced into the sulfur containing polymer of the functionalised film by treating the functionalised film to a phase inversion wetting process. During the phase inversion wetting process, the functionalised film is provided in an organic solvent, such as DMF and is then contacted, for example, by immersion, into a non-solvent phase, such as water. This results in the formation of two phases, a polymer rich phase and a polymer poor phase, whereby solvent/non-solvent exchange process results at the phase interface in the formation of the nanoporous structure in the sulfur containing polymer component in the film's pores.

Also described is a lithium metal anode for an energy storage device comprising an electrically conducting fabric has an interconnected network of fibres functionalized with one or more lithiophilic materials.

Suitably, the fabric is a flexible fabric.

Desirably, lithium metal is insertable, storable and removeable from gaps or spaces between the functionalised fibres.

In a related aspect, the invention provides a lithium metal anode for an energy storage device comprising an electrically conducting fabric has an interconnected network of fibres functionalised with one or more lithiophilic materials, wherein lithium metal is provided into gaps or spaces between the functionalised fibres. It will be understood that the lithium metal also sits within nanostructures formed from the lithiophilic materials.

In a related aspect, there is provided a lithium metal anode for an energy storage device comprising a flexible electrically conducting fabric having an interconnected network of fibres, wherein each fibre is functionalised with one or more lithiophilic materials, whereby lithium metal is insertable, storable and removeable from gaps or spaces between the functionalised fibres.

The flexible anode of the invention is more resistance than lithium metal to a permanent distortion arising from local extraction, such as one or more of wrinkling, creasing and buckling. The flexible anode of the invention is more resistant to volume changes which occur during lithium stripping/plating cycles compared to lithium metal.

The excellent mechanical property and the hierarchical nanostructure networks of the functionalised fabric anode greatly contributes to the unprecedented flexibility and stability of these flexible lithium anodes.

In the lithium metal anode as defined herein, the lithium metal anode comprises a fabric, preferably comprising a network of interconnected, preferably interlaced or interwoven fibres. The network of interconnected, interlaced or interwoven fibres form a microstructure comprising a 3-D fibre structure which give the fabric an overall porous structure where gaps and/or spaces are formed between the fibres, into which lithium metal can be inserted, stored and removed. In other words, the microstructure of the fibre network together with the nanostructure imparted by the lithiophilic material on the functionalised fibres allow the fabric to function as a lithium metal host.

Fabrics having high flexibility are preferred for flexible Li—S energy storage devices as they need to be bent and folded repeatedly for more than 3000 cycles without breaking or significant lost in performance. Furthermore, only fabrics having sufficiently high electrical conductivity as well as a large surface area are suitable for use in flexible Li—S energy storage devices. In addition, an ideal fabric will be chemically stable under the environmental conditions experienced in an energy storage device. Furthermore, still preferred fabrics will retain these characteristics following hydrothermal treatment in which metal oxides such as (i.e. MnO₂) can be grown on the fabric to improve the fabric's surface chemistry, particularly with respect to the wettability of molten lithium. Finally, the fabric should maintain the mechanical strength and elasticity under a significant amount of bending, folding and stretching. Therefore, carbon cloth is one suitable material with the required high mechanical flexibility and other properties. Furthermore, preferred fabrics have a 3D porous structure/3D microstructure suitable for limiting Li dendrite formation which is a component of device degradation. Suitably, the fabric is a carbon cloth. Preferably, the fabric is an electrically conducting fabric, such as electrically conducting carbon cloth. A preferred fabric has an electrical resistivity is 1.4×10⁻³ Ω·cm.

Suitably, the fabric is functionalised with nanostructures of one or more lithiophilic materials. Functionalising the fabric, and particularly the fibres of the fabric with lithiophilic material assist in adsorption of lithium metal by the fabric host. More suitably, the nanostructures are 3D lithiophilic nanostructures, preferably in nanoflake or nanosheet form which significantly increases the surface area of the fabric. In a particularly preferred embodiment, the 3D lithiophilic nanostructures comprise MnO₂. Most preferable, the 3D lithiophilic nanostructures comprise 3D hierarchical MnO₂ nanosheets. Suitably, the nanostructures are homogenously fabricated on the fabric's fibres.

Desirably, the lithium metal is associated with the fabric fibres and/or the nanostructures. Most preferably, the lithium metal is associated with the fabric fibres and the nanostructures.

Suitably, during manufacture of the anode, the lithium metal is associated with the anode in the form of a molten lithium metal infusion. Preferably, the lithium loading on the lithium metal anode is from about 2 mg cm⁻² to about 10 mg cm⁻². In some embodiments, the lithium metal loading is preferably 3 mg cm⁻² or 6 mg cm⁻².

In a particularly preferred embodiment, the lithium metal anode of the invention is a flexible lithium metal anode.

Also described is a method of preparing a lithium metal anode for an electrochemical cell comprising the steps of:
(i) functionalising an electrically conducting fabric with one or more lithiophilic materials;
(ii) associating the functionalised fabric with lithium metal.

Suitably, the fabric is flexible.

Preferably, the fabric is an electrically conducting fabric, such as an electrically conducting carbon cloth, most preferably, carbon cloth, for example, a commercially available carbon cloth.

Desirably, the step of functionalisation the fabric with the lithiophilic materials involves a hydrothermal method with for example potassium permanganate powder, concentrated hydrochloric acid and deionized water. A hydrothermal method is single crystal growth technique whereby crystals are grown from a high temperature aqueous solution at a high vapor pressures, for example, in an Teflon lined autoclave at high temperature and pressure.

Suitably, the step of associating the functionalised fabric with lithium metal involves infusing the fabric with lithium, preferably, molten lithium metal. Desirably, this can be achieved by contacting an edge of the functionalised fabric with molten lithium metal.

Preferably, the associating step is carried out under an inert atmosphere, preferably an argon atmosphere.

In a preferred embodiment, the method further comprises the additional step of adjusting the infusion time to control the amount of lithium associated with the fabric. In other words, adjusting the infusion time allows the lithium mass loading to be controlled. In a preferred embodiment, the infusion time is controlled to give a lithium mass loading of about 3 mg cm⁻¹.

Suitably, at least one of the lithiophilic materials is nanostructured. Such a morphology increases the surface area of the host. Preferably, the lithiophilic material is a metal oxide, such as MnO₂, SnO₂, ZnO, Co₃O₄, preferably in nanoflake form, most preferably 3D hierarchical MnO₂ nanosheets, ideally grown on the surface of the fabric and particularly the fibres of the fabric. Most preferably, ultra-thin nanosheets of the lithiophilic material are homogenously fabricated on the carbon fibres. This arrangement significantly enhances the surface area of the fabric.

Preferably, in the energy storage devices described herein, the cathode is a graphene/sulfur cathode, preferably, a graphene/sulfur cathode with a selective functional interlayer suitable for reducing polysulfide shuttling effects and/or to reduce charge transfer resistance. In one embodiment, an example of such an interlayer is a boron nitride/graphene (FBN/G) interlayer, for example, to provide a sulfur/graphene/boron nitride nanosheet cathode.

Suitable the cathode is a free-standing cathode.

In a particularly preferred embodiment, the cathode as described herein is a flexible cathode.

In particular, when a graphene/sulfur cathode protected with FBN/G interlayers is used in a device together with the sulfur containing polymer functionalised separator of the invention, it is believe that due to a synergistic effect between these components, the energy storage device can reach a long cycle life even at a folder or bent state, while exhibiting high volumetric density and gravimetric energy densities.

In a third aspect of the invention, there is provided an energy storage device comprising:
a lithium metal anode;
a cathode comprising sulfur and one or more electrically conducting substances; and
a separator as defined in the first aspect of the invention positioned between the anode and the cathode.

Also described is an energy storage device comprising
a lithium metal anode as defined in the third aspect of the invention;
a cathode comprising sulfur and one or more electrically conducting substances; and
a separator positioned between the anode and the cathode.

Also described is an energy storage device comprising
a lithium metal anode as defined in the first aspect of the invention;
a cathode comprising sulfur and one or more electrically conducting substances; and
a separator as defined in the first aspect of the invention positioned between the anode and the cathode.

In a preferred energy storage device of the invention, one or more of the anode and the cathode are free standing. In other words, no additional current collector components, particularly metallic current collectors are required where the anode and/cathode described herein are used in an electrochemical cell and the electrically conducting fabric and/or the graphene of the cathode are sufficiently electrically conductive obviating the need for additional current collector component. This advantageously means the device mass can be reduced meaning higher gravimetric and volumetric energy densities are possible in devices using these components.

In a particularly preferred embodiment, the energy storage device of the invention is a flexible energy storage device. Flexible means the respective components and/or the energy storage device can be bent or folded or subjected to one or more physical deforming forces without experiencing a significant increase in electrical resistance, that is, without loss of electrical conducting ability. For example, a preferred electrically conductive fabric on experiencing a manual deforming force, such as a crease fold, that is a 90° fold, or an edge to edge fold, for example, a 180° fold, under the fabric's own weight, retains its electrical resistance to within ≤50% of its original resistivity value, more preferably to within ≤25%, most preferably to within ≤10% of the original resistivity value.

Suitably, one or more of the anode, cathode and separator are flexible which when enclosed in a suitably flexible housing forms a flexible energy storage device. Preferably, the components of the energy storage device are encased in a flexible housing, preferably a flexible pouch, for example, a flexible Al-plastic film envelope. Particularly preferred housings are moisture impermeable.

A preferred energy storage device comprises:
a flexible lithium metal anode for an energy storage device comprising an electrically conducting fabric functionalised with one or more lithiophilic materials;
a flexible cathode comprising sulfur and one or more electrically conducting substances; and
a flexible separator for an energy storage device, wherein the separator comprises one or more porous films of Li ion selective permeable material wherein at least a portion of the pores of the film are associated with a porous sulfur containing polymer positioned between the anode and the cathode.

A particularly preferred energy storage device comprises:
a flexible lithium metal anode for an energy storage device comprising an electrically conducting fabric functionalised with a 3D hierarchical MnO₂ nanosheet lithiophilic material;
a flexible graphene/sulfur cathode protected by a FBN/G interlayer; and
a flexible separator for an energy storage device, wherein the separator comprises one or more microporous films of Li ion selective permeable polyolefin material wherein at least a portion of the pores of the film are associated with nanoporous polysulfone polymer positioned between the anode and the cathode.

In a preferred device, all components in the flexible cells, including cathode, anode, separator, electrolyte, and current collectors, are mechanically flexible enough to withstand repeated mechanical deformation while continuing to maintain continuous electron/ion pathways and prevent cell failure. The flexible energy storage device of the invention demonstrates excellent mechanical flexibility and electrochemical performance with a super-long cycling life and high energy density. All the components possess excellent mechanical properties, contributing to the good electrochemical performance of the cell when being repeatedly bent or folded. The volume change and dendrites growth of the lithium anodes are confined by the stable and conductive interconnected network of the functionalized fibres of the fabric. The sulfur containing polymer functionalised separator leads to the improvements to the mechanical performance and thermal stability of the separators, and further improve the safety of the full cells. Both the cathode and the separator are modified to trap the polysulfides and block the pathway to the anodes for the polysulfides, therefore inhibiting the shuttle effects.

The device comprising the freestanding ultra-stable lithium fabric anode of the invention, the sulfur containing polymer functionalised separator of the invention and a free-standing graphene/sulfur cathode protected by a FBN/G interlayer, enables a device having both exceptionally higher energy density and mechanical flexibility.

Suitably, the energy storage device further comprises electrolyte. A preferred electrolyte is an organic liquid comprising lithium salts.

Desirably, in the energy storage device of the invention, the electrolyte is present in an electrolyte to sulfur (E/S) ratio of about 5/1 to 30 [mL g⁻¹]. In a preferred embodiment, the electrolyte to sulfur (E/S) ratio is about 20/1 [mL g⁻¹].

Suitably, the electrolyte may comprise an organic liquid comprising lithium ions for example an organic solvent in combination with one or more lithium salts. In one preferred embodiment, the electrolyte may comprise LiTFSI with LiNO₃ for example. In one preferred embodiment, the electrolyte is 1 M LiTFSI in DOL/DME with 1 wt % LiNO₃.

A particularly preferred energy storage device retains up to 60% of the initial capacity after at least 800 cycles at a current density of 0.5 C.

A particularly preferred energy storage device exhibits a volumetric energy density of at least about 100 Wh L⁻¹, more preferably at least about 300 Wh L⁻¹, most preferably still at least about 500 Wh L⁻¹, after 800 cycles in a folded state.

A particularly preferred energy storage device exhibits a gravimetric energy density of at least about 75 Wh Kg⁻¹, more preferably at least about 250 Wh Kg⁻¹, most preferably at least about 470 Wh Kg⁻¹, after 800 cycles in a folded state.

In one embodiment, a folded state means a bend angle of up to and including 90°. In one embodiment, a folded state means a bend angle of up to and including 180°.

A particularly preferred energy storage device exhibits a capacity of about 3,500 mAh g⁻¹ based on lithium weight after charging to 1 volt.

A preferred energy storage device is one wherein one or more of the anode, cathode and separator are flexible and can be bent into a 90° configuration while retaining up to about 60% of the initial capacity after at least 800 cycles at a current density of 0.5 C.

A further preferred energy storage device is one wherein one or more of the anode, cathode and separator are flexible and can be folded in a 180° configuration while retaining up to 60% of the initial capacity after at least 800 cycles at a current density of 0.5 C.

The term ‘about’ generally means from +5% of the stated value unless otherwise stated.

In a fourth aspect of the invention, there is provided a use of a porous sulfur containing polymer as a pore filler in a porous film of a Li ion selective permeable material. Preferably, wherein the pore filled Li ion selective permeable material is used as a separator for an energy storage device, particularly, a lithium-sulfur energy storage device.

In a fifth aspect of the invention, there is provided a use of a separator for an energy storage device, wherein the separator comprises one or more porous films of Li ion selective permeable material wherein at least a portion of the pores of the film are associated with a porous sulfur containing polymer in an energy storage device, particularly a lithium sulfur battery.

Also described is a use of a lithium metal anode comprising an electrically conducting fabric functionalized with one or more lithiophilic materials in an energy storage device, particularly a lithium sulfur battery.

In a sixth aspect of the invention, there is provided an electronic device comprising the separator of the first aspect, the lithium metal anode of the second aspect, and/or the energy storage device of the third aspect. Desirably, the electronic device is a wearable device. Suitably, the electronic device is an electronic watch, and LED or an LED screen.

### BRIEF DESCRIPTION OF DRAWINGS

FIG. 1 illustrates a schematic of the design and fabrication of flexible Li—S full cells. Flexible Li—S full cells are fabricated using lithium cloth anodes, PSU-Celgard separators and FBN/G interlayer protected free-standing graphene/sulfur cathodes;

FIG. 2 illustrates the fabrication and characterisation of lithium cloth anodes. (a) Schematic of the material design and the consequent synthetic procedures. (b-d) SEM images of the functionalized carbon cloth, (e-g) SEM images of the obtained lithium cloth, (h) Optical photograph of the twisted lithium cloth, and (i) XRD patterns of the functional carbon cloth and lithium cloth;

FIG. 3 illustrates the electrochemical stability and mechanical stability of symmetric pouch cells base on lithium cloth electrodes. (a) Galvanostatic cycling performance of the symmetric pouch cells based on lithium cloth electrodes at flat state and bent state, (b) Schematic illustration of the assembled symmetric pouch cells, (c) Voltage profiles of the 100th, 200th and 250th cycles, (d) full Li stripping curve of the Li cloth electrode to 1 V versus Lit/Li. SEM images of the lithium cloth electrodes after 250th stripping (e) and 250th stripping/plating (f, g);

FIG. 4 illustrates the fabrication and characterisation of the PSU functionalised separators. (a) Schematic of the synthetic procedures of PSU-Celgard separators. Top-view SEM images of (b) Pristine Celgard 2400 and (c) PSU-Celgard separators. Side-view SEM images of (d) Pristine Celgard 2400 and (e) PSU-Celgard separators. TGA curves (f), FTIR spectra (g), lon conductivity (h) of pristine Celgard 2400 and PSU-Celgard separators. (i) Contact angle of electrolyte vs. pristine Celgard 2400 and PSU-Celgard separators. (j) Optical photo of the H bottle system with a PSU separator;

FIG. 5 illustrates the electrochemical performance of Li—S testing coin cells. (a) Charge/discharge curves of the Li—S test cell at 1st, 50th, 100th, 200th and 500th cycles, (b) cycling and (c) rate performance of the Li—S test cells and Li—S control cells, low and high magnification SEM images of the different anodes and separators after 500 cycles: (d, e) the lithium cloth anode (f, g) the lithium foil anode, (h, i) the PSU-Celgard separator and (j, k) the Celgard separator;

FIG. 6 illustrates the electrochemical performance and applications of flexible Li—S pouch cells. (a) Schematic illustration of the structure of a flexible Li—S pouch cell, (b) Charge/discharge curves and (c) Cycling performance of the Li—S pouch cells, (d) Charge/discharge curves of the soft-packaged Li—S cell bent at different angles, and (e) Comparison of the volumetric (Wh L_{cell}⁻¹)/gravimetric (Wh kg_{cell}⁻¹) energy densities of the reported flexible Li—S batteries. (f) Optical photographs of a flexible Li—S full-cell battery powers LED lights at bent state, (g) Electric watch at folded state and a LED screen with single-chip under flat (h) and bent (i) states;

FIG. 7 illustrates a photograph of (a) carbon cloth and (b) functionalised carbon cloth contacting with the molten lithium, and the photograph of the obtained lithium cloth with a lithium mass loading of (c) ˜3 mg cm⁻² and (6) ˜6 mg cm⁻²;

FIG. 8 illustrates nitrogen adsorption isotherms of functionalised carbon cloth and lithium cloth;

FIG. 9 illustrates low and high magnification SEM images of commercial carbon cloth;

FIG. 10 illustrates a photograph and (b) the SEM image of the free-standing graphene/sulfur with FBN/G interlayer. (c) The low and (d) high magnification SEM images of FBN/G interlayer.

### DETAILED DESCRIPTION

The inventors have devised flexible lithium-sulfur full cells which are designed and fabricated with ultra-stable lithium cloth anodes, polysulfone-functionalised separators and free-standing sulfur/graphene/boron nitride nanosheet cathodes. Because of successful control of shuttle effect and dendrite formation, the flexible lithium-sulfur full cells exhibit excellent mechanical flexibility and outstanding electrochemical performance with a super-long cycling life of 800 cycles in folded state and unprecedented high volumetric and gravimetric energy densities of 497 Wh L-land 463.6 Wh kg⁻¹, respectively.

TABLE 1
Performance metrics of the flexible Li—S full batteries

| | | Cell | | | Volumetric | Gravimetric |
|---|---|---|---|---|---|---|
| Anode// | Cell weight | thickness | Sulfur loading | Areal capacity | cell capacity | cell capacity |
| Cathode | (mg cm⁻²) | (μm) | (mg cm⁻²) | (mAh cm⁻²) | (Wh L⁻¹) | (Wh kg⁻¹) |
| Li cloth// | 17.15 | 160 | 3.5 | 3.79 | 497 | 463.6 |
| Graphene-S | | | | | | |

Experimentally, the mass of lithium cloth anode with 3 mg cm⁻², the cathode with the interlayer and the PSU-Celgard separator are 9.3 mg cm⁻², 6.5 mg cm⁻² and 1.35 mg cm⁻², respectively. The measured thickness of lithium cloth and the cathode is ˜135 μm under standard stress (400 N cm⁻², a pressure used for the compression of standard coin cells). The thickness of the separator is typically ˜25 μm. The gravimetric and volumetric densities are calculated based on the total weight and volume of the current collector, electrodes, and the separator.

The flexible Li—S full cell of the invention is based on an ultra-stable lithium cloth anode, a polysulfone (PSU) functionalised separator and free-standing graphene/sulfur cathode protected by a FBN/G interlayer, enabling both exceptionally higher energy density and mechanical flexibility. The ultra-stable and flexible lithium cloth anodes are fabricated by coating lithium via molten lithium infusion on pre-functionalised carbon cloth. The excellent mechanical property and the hierarchical nanostructure networks of the functionalised carbon cloth greatly contributes to the unprecedented flexibility and stability of lithium cloth electrodes. In addition, commercial separators, Celgard 2400, are filled with PSU via a vacuum and phase inversion process, resulting in smaller pore size, better thermal and mechanical stability. Because of the synergistic effect of PSU filler and the FBN/G interlayers, the final full cells can reach a long cycling life of 800 cycles at folded state and very high volumetric density 497 Wh L⁻¹ and gravimetric energy densities 464 Wh kg⁻¹. One flexible Li—S pouch cell is capable to power several LED lights or an electronic watch; three connected flexible cells can light a LED screen with a single-chip working nominally at a voltage of 5V both under flat and bent states.

### Results

Design of flexible Li—S full cells.

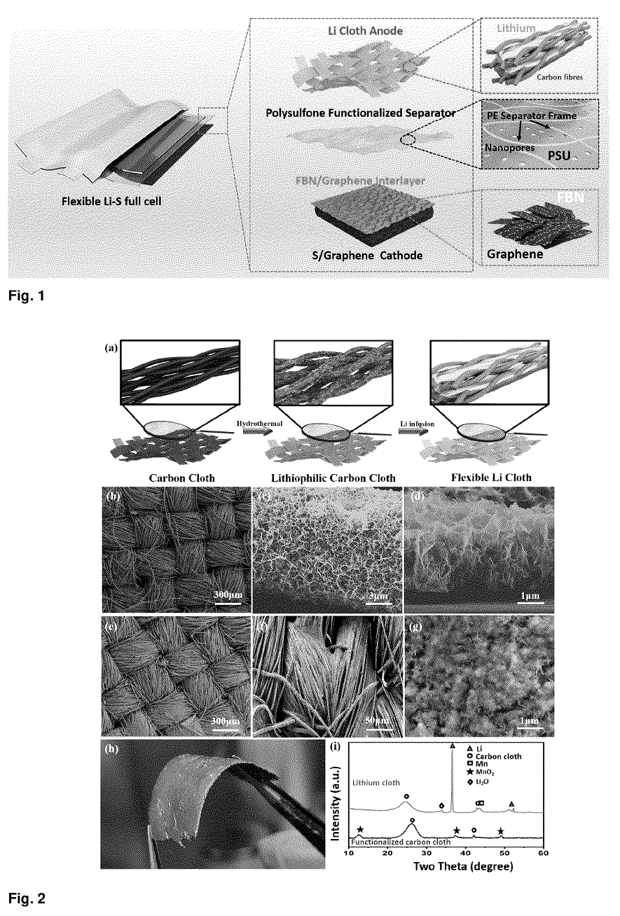

FIG. 1 depicts the structure of a flexible Li—S full cell including flexible lithium anode, separator and sulfur cathode. The flexible anode, lithium cloth, was synthesised via pre-storing lithium into the carbon cloth functionalised with 3D lithiophilic MnO₂ nanoflakes. A novel approach of “phase-inversion” process was utilised to reduce the large pore size of the commercial separators with PSU. FBN/graphene interlayer was employed to cover the free-standing graphene/sulfur cathodes.

### Lithium Cloth Electrodes

The fabrication of lithium cloth includes two steps: functionalising carbon cloth with 3D lithiophilic nanostructures and storing Li into the functionalised hosts via a molten lithium infusion process (FIG. 2a). Excellent lithiophilicity of the host materials is a prerequisite for molten Li infusion. Commercial carbon cloth shows a poor lithiophilicity and does not adsorb molten lithium (FIG. S1a). To improve surface lithiophilicity, 3D hierarchical MnO₂ nanosheets were grown on the surface of the carbon cloth, which not only provides the carbon cloth with excellent lithiophilicity but also large surface areas (FIG. S2). The second step is to homogeneously infuse Li into the functionalised carbon cloth. Fast and uniform Li intake can be fulfilled by simply bringing the edge of the functionalised carbon cloth into contact with molten Li (FIG. S1b). The silvery lithium quickly spreads across the whole cloth and finally flexible lithium cloth can be obtained. The amount of the lithium pre-stored in the functionalised carbon cloth can be controlled by adjusting the infusion time (FIG. S1c and d). The morphology and structure of functionalised cssarbon cloth and the obtained lithium cloth are shown in FIG. 2.

### Fabrication and Characterisation of Lithium Cloth Anodes

FIG. 2a shows a schematic of the material design and the consequent synthetic procedures. FIGS. 2b to 2d show SEM images of the functionalised carbon cloth, FIGS. 2e to 2g shows SEM images of the obtained lithium cloth, FIG. 2h shows an optical photograph of the twisted lithium cloth, and FIG. 2i shows XRD patterns of the functional carbon cloth and lithium cloth. FIG. 2b shows a low magnification top-view SEM image of the functionalised carbon cloth. Typical textile structure of porous interlaced microstructures can be seen clearly. The SEM image in FIG. 2c is a high magnification top-view of the functionalised carbon cloth and FIG. 2d is the side-view SEM image of the hierarchical MnO₂ nanostructures, respectively. It can be seen clearly that 3D hierarchical network constructed with ultra-thin nanosheets are homogenously fabricated on the carbon fibres, which significantly enlarge the surface area of the cloth. FIG. 2e and FIG. 2f are the low magnification SEM images of lithium cloth with a lithium mass loading of ˜3 mg cm⁻². The lithium cloth also possesses an interlaced structure. High-magnification SEM image (FIG. 2g) shows that the inner space of the porous network is filled with lithium. The results demonstrate that the lithium is completely confined within the gaps between the fibres as well as the nanoscale networks. In addition, the obtained lithium cloth can be easily twisted (FIG. 2h), indicating excellent flexibility of the lithium cloth. XRD patterns (FIG. 2i) reveal the presence of lithium stored in the cloth.

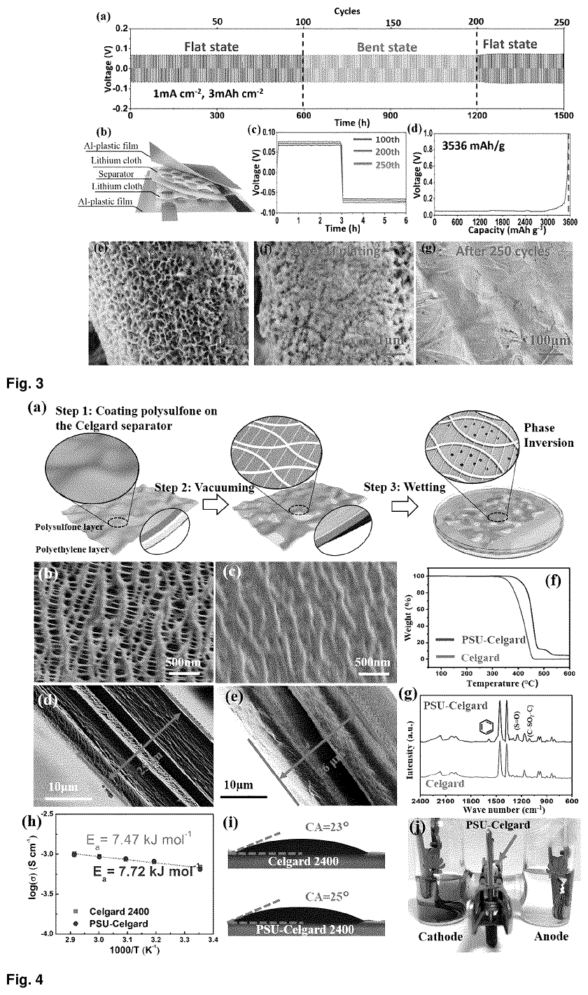

The electrochemical sustainability of the flexible lithium cloth was investigated using symmetric pouch cells. Two identical lithium cloth electrodes were assembled into a pouch cell as shown in FIG. 3b. The lithium cloth electrodes have a mass loading of ˜3 mg/cm² lithium. The galvanostatic cycling performance of the cells was investigated at a current density of 1 mA cm⁻² and a capacity density of 3 mAh cm⁻² (FIG. 3a). The symmetrical lithium cloth cell exhibits a stable voltage hysteresis of ˜120 mV for 100 cycles, which is admitted as the sum of overpotential for Li stripping and Li plating. After cycling 100 times, the cell was folded and went on another 100 cycles. The flat voltage plateau at both the charging and discharging states can be retained throughout the whole 100 cycles without obvious increases in hysteresis. After 200 cycling, the cell was unfolded and cycled for another 50 times, the results show that the cell still exhibits outstanding cycling stability and constantly low hysteresis. To further study the evolution of the voltage profiles in detail, the 1st (flat state), 200th (bent state) and 250th cycle (flat state) of the symmetrical cell are enlarged and presented in FIG. 3c. No obvious voltage hysteresis increase can be found between these three voltage profiles, indicating a high stability and flexibility of the lithium cloth electrodes in both bent and flat states. In addition, lithium cloth electrodes not only exhibit outstanding electrochemical properties but also retain most of the capacity. As shown in FIG. 3d, a capacity of ˜3,536 mAh g-1 (based on the weight of lithium) can be extracted when charged to 1 V, which is very close to the theoretical capacity of pure Li anode (˜91.4% capacity retention compared with pure Li). Therefore, the functionalised carbon cloth of the invention offers an exciting possibility of fabricating high-performance lithium anodes with both high cycling stability and capacity. To check the morphology variation of the lithium cloth electrodes after a high-number of plating/stripping cycles, the symmetrical pouch cells are disassembled after 250th stripping and 250th stripping/plating cycle. The high-magnification SEM images of the lithium cloth electrodes (FIG. 3e) show that the space in the network originally filled by metallic Li returned to its previous 3D hierarchical porous structure after Li was stripped. This also indicates that the surface nanostructure does not change during the initial Li infusion and later cycling. After Li plating, most of the space of the porous structure was filled again (FIG. 3f), close to the morphology of the electrodes after lithium infusion. The low-magnification SEM of the lithium cloth electrode after 250 cycles shows a smooth surface of the lithium cloth without observable dendrite formation.

### Electrochemical Stability and Mechanical Stability of Symmetric Pouch Cells Base on Lithium Cloth Electrodes

FIG. 3a shows galvanostatic cycling performance of the symmetric pouch cells based on lithium cloth electrodes at flat state and bent state, FIG. 3b shows a schematic illustration of the assembled symmetric pouch cells, FIG. 3c shows voltage profiles of the 100th, 200th and 250th cycles, FIG. 3d shows a full Li stripping curve of the Li cloth electrode to 1 V versus Li+/Li. SEM images of the lithium cloth electrodes after 250th stripping are shown in FIGS. 3e and 250th stripping/plating is shown in FIG. 3f and FIG. 3g.

### Fabrication and Characterization of the PSU Functionalised Separators

FIG. 4a shows Schematic of the synthetic procedures of PSU-Celgard separators. Top-view SEM images of FIG. 4b shows pristine Celgard 2400 and FIG. 4c shows PSU-Celgard separators. Side-view SEM images, FIG. 4d shows pristine Celgard 2400 and FIG. 4e shows PSU-Celgard separators. TGA curves: FIG. 4f, FTIR spectra: FIG. 4g, Ion conductivity: FIG. 4h of pristine Celgard 2400 and PSU-Celgard separators. FIG. 4i shows the contact angle of electrolyte vs. pristine Celgard 2400 and PSU-Celgard separators. FIG. 4j shows optical photo of the H bottle system with a PSU separator.

Synthetic procedure of PSU-Celgard separators consists of 3 steps: coating, vacuuming and wetting, as shown in FIG. 4a. Compared to the previous coating strategies for separators, the additional layer of coating materials was removed from the surface of the Celgard separators, and the left large pores in the separator were filled by PSU after vacuuming, leading to a significantly reduction of the weight of coating materials. In addition, phase inversion strategy was used to making micropores in the PSU. When the polymer and DMF (solvent phase) were immersed into water (non-solvent phase), the thermodynamic equilibrium was instantaneously broken and formed two phases (polymer-rich phase and polymer-poor phase). The solvent-non-solvent exchange process immediately occurred on the slurry/water interface, leading to a porous structure (Inset of FIG. 4a). The mass loading of the PSU is ˜0.12 mg cm⁻². Large pores (above 100 nm) of the commercial Celgard separator can be observed (FIG. 4b). After combining with PSU, the pores are filled and the frames of the separator are still can be seen clearly (FIG. 4c), and its thickness (˜25 μm) is nearly the same as the thickness of original thickness of the separator (˜26 μm) (FIG. 4d and FIG. 4e). Compared to most of the previous strategies, where additional layers are coated on the commercial separators, the present method will facilitate thickness reduction of the final batteries. The thermal stability of the separators was examined using thermal gravimetric analyzer (TGA) (FIG. 4f). A significant weight loss of Celgard 2400 separator starts from 250° C., while the PSU-Celgard separator does not have any weight change until 360° C. and a second weight loss occurs at ˜ 500° C. This higher thermal stability of the modified separator can be attributed to the introduction of more stable PSU of higher melting temperature ˜520° C. The surface chemical changes of Celgard separators functionalised with the PSU were evaluated by Fourier-transform infrared spectroscopy (FTIR) (FIG. 4g). Besides all the characteristic peaks of polyethylene, three new peaks at 1583 cm⁻¹, 1335 cm⁻¹ and 1153 cm⁻¹ can be observed from the spectrum, corresponding to the stretching vibration bands of the benzene ring, sulfone (C—SO₂—C) and sulfonyl group (O═S═O) of PSU, respectively, indicting the successful introduction of the PSU in the Celgard separator. The ionic conductivity of the Celgard separator before and after being filled with PSU was evaluated using stainless steel symmetric cells. FIG. 4h shows the temperature dependency of ionic conductivity for both Celgard separator and PSU-Celgard separator. The activation energy was estimated using Arrhenius equation:

$$σ ( T ) = A exp ( - \frac{{E}_{a}}{R T} ) \qquad ( 1 )$$

where σ(T) is the ionic conductivity at temperature T, A is the pre-exponential factor, Eₐ is the activation energy, and R is the ideal gas constant. The results show that the ionic conductivity of Celgard separator is 6.87 mS cm⁻¹, and PSU-Celgard separator 6.41 mS cm⁻¹ at 25° C., respectively. Moreover, the activation energy also exhibits negligible difference. This indicates PSU has no negative effect on ion conduction. Furthermore, wettability to the electrolyte is also a key factor for the separator, which was characterised by the contact angle of the electrolyte vs. the separators. The PSU-Celgard separators provide the same wettability to the electrolyte with the pristine Celgard 2400 separators, which is indicated by the almost identical contact angles of the electrolyte vs. Celgard 2400 and PSU-Celgard separators. To demonstrate the ability to inhibit the shuttle effects of polysulfides, a model-battery was set up in an “H bottle” where sulfur cathodes and lithium foil anodes were located at the opposite sides and a PSU-Celgard separator is in the middle. (FIG. 4i). After 10 cycles, the electrolyte at the cathode side turned to yellow, while the electrolyte at the anode side still keeps the original colour, which is a strong evidence that PSU-Celgard separators successfully prevent the migration of polysulfide ions through it and thus inhibit the shuttle effects of polysulfides.

### Electrochemical Performance of Li—S Coin Cells

To evaluate the performance of the new anodes and separators, testing coin cells were fabricated with lithium cloth anodes, PSU-Celgard separators and FBN/G interlayers protected graphene/S cathodes. The highly porous graphene and high surface graphene are mixed as the host for the sulfur cathodes. The freestanding graphene/sulfur cathodes were further coated with a FBN/G interlayer to protect the cathode. The morphologies of the cathodes are shown in FIG. S4.

### Electrochemical Performance of Li—S Testing Coin Cells

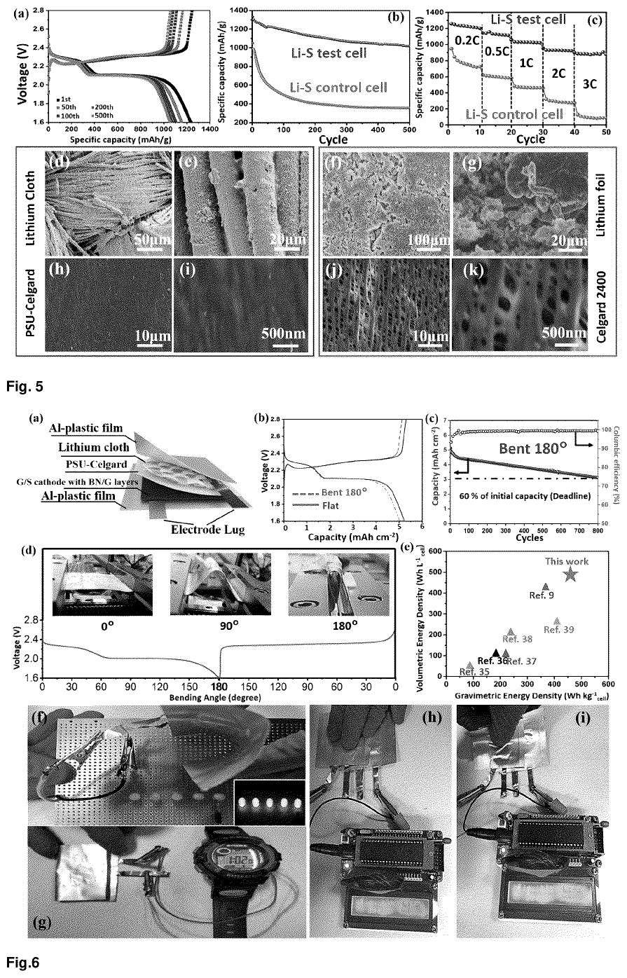

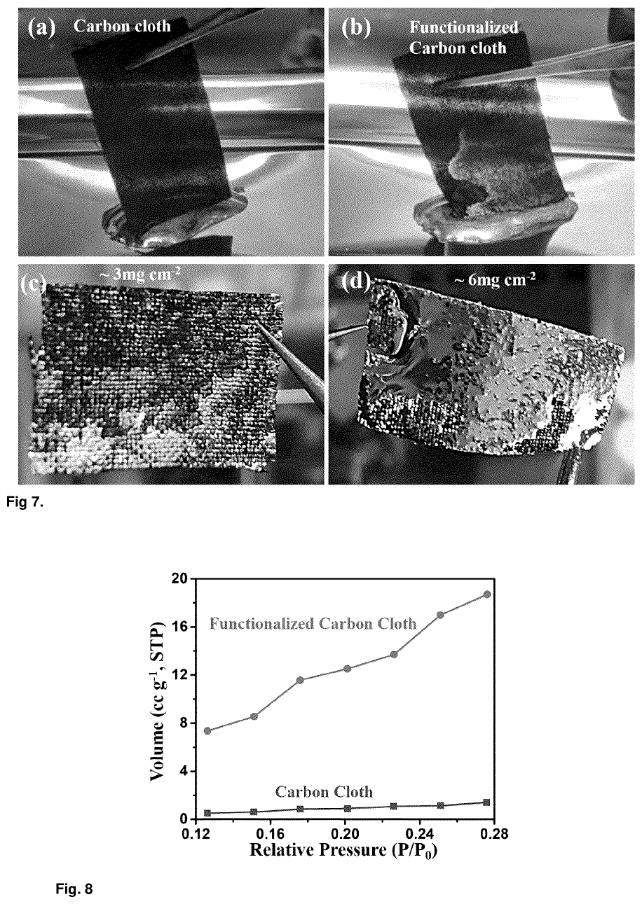

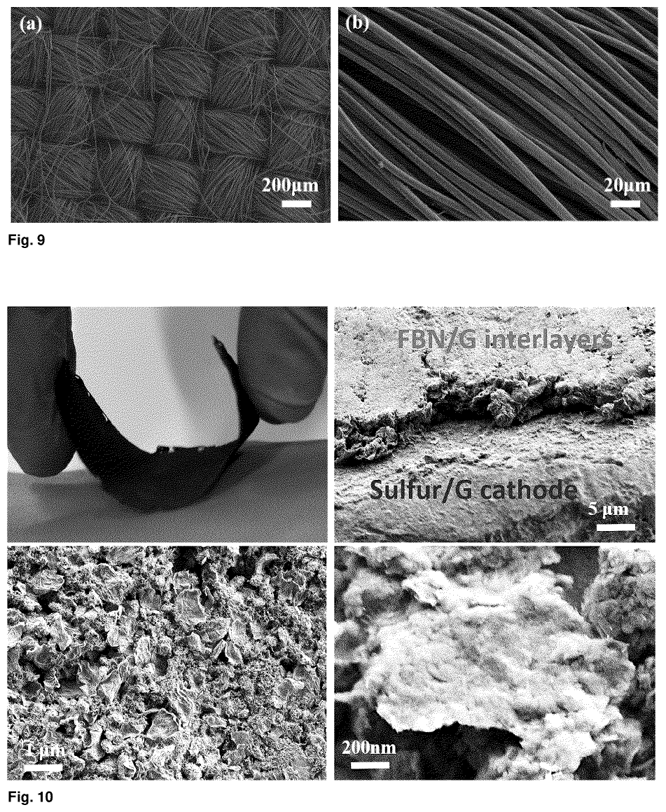

FIG. 5a shows charge/discharge curves of the Li—S coin cell at 1^{st}, 50^{th}, 100^{th}, 200^{th} and 500^{th} cycles, FIG. 5b shows cycling performance, and FIG. 5c shows rate performance of the Li—S cells and control Li—S cells, low and high magnification SEM images of the different anodes and separators after 500 cycles are shown in FIG. 5d to FIG. 5k. The lithium cloth anode is shown in FIG. 5d and FIG. 5e the lithium foil anode is shown in FIG. 5f and FIG. 5g, the PSU-Celgard separator is shown in FIG. 5h and FIG. 5i, while the Celgard separator is shown in FIG. 5j and FIG. 5k.

The mass loading of the sulfur in the cathodes was controlled to 2 mg/cm². FIG. 5a shows the discharge/charge curves of the Li—S testing cells at different cycles at a current density of 0.2 C. Two discharge/charge plateaus are well-retained even after 500 cycles. The cycling performance of the testing cells are illustrated in FIG. 5b. A Li—S coin cell with lithium foil anode, Celgard 2400 separator and graphene/sulfur cathode is used as a control cell. The Li—S testing cell delivers an initial discharge capacity of 1320 mAh g⁻¹ at a current density of 0.2 C, and the capacity is retained at 1100 mAh g⁻¹ after 500 cycles. The decay per cycle of the Li—S cells is ˜0.0334%, which is much lower than that of the control cell (˜0.15%). The rate performance of the testing cells possess high capacities of 1200 mAhg⁻¹, 1112.8 mAhg⁻¹, 1020.5 mAhg⁻¹, 921 mAhg⁻¹ and 877 mAhg⁻¹ at 0.2C, 0.5C, 1C, 2C and 3C rates, respectively (FIG. 5c). The post-mortem analysis after 500 cycles was conducted to investigate the morphology change of the anode and the separator. After 500 cycles, the surface of the lithium cloth anode remains interwoven. Moreover, no lithium dendrites can be found (FIG. 5d and FIG. 5e). In contrast, the surface of the Li foil electrode in the control cell shows a typical lithium dendritic morphology with random arrangement after 500 cycles (FIG. 5f and FIG. 5g). The formation and growth of lithium dendrite can result in continuous consumption of electrolyte and fresh lithium, and finally cause the depletion of electrolyte and the collapse of electrodes, which may be responsible for the larger decay of the control cell. FIG. 5h and FIG. 5i are the SEM images of the PSU-Celgard separators after 500 cycles, no large pores can be observed. In contrast, some pores of the commercial separators became much larger after 500 cycles.

### Flexible Li—S Pouch Cells

Flexible Li—S pouch full batteries were fabricated as shown in FIG. 6a. Free-standing graphene/sulfur composites are used as the cathodes with a mass loading of about 3.5 mg cm-2 (sulfur) and lithium cloth as anodes. The pouch cells were sealed in an Al-plastic film envelope after adding the appropriate electrolyte. FIG. 6b and FIG. 6c show the discharge/charge curves and cycling performance of the flexible Li—S pouch cells under flat and bent states. Two discharge/charge plateaus can be clearly observed both under flat and bent states, and the discharge capacity of the batteries under flat and bent states are 5.13 mAh cm⁻² and 5.02 mAh cm⁻², respectively. The cycling performance of the battery is tested under bent state at 180° and the capacity retains up to 60% of the initial capacity after 800 cycles at a current density of 0.5 C. This super long lifetime can be attributed to the excellent mechanical properties and electrochemical stabilities of the lithium cloth anodes and graphene/sulfur cathodes. The discharge/charge performance of the battery is tested during the bending process (FIG. 6d and insets). No voltage fluctuation can be found in the discharge/charge curves, indicating a stable electrochemical performance under the bent state. The volumetric energy density and the gravimetric energy density of the Li—S pouch cells are calculated based on the parameters of the cells (Table S1). Compared with the previously reported data of flexible Li—S cells 35-40, the present Li—S full cells based on lithium cloth anodes and graphene/sulfur cathodes exhibit a higher volumetric energy density of 497 Wh L⁻¹ and a higher gravimetric energy density of 464 Wh kg⁻¹ (FIG. 6e).

### Electrochemical Performance and Applications of Flexible Li—S Pouch Cells

FIG. 6a shows a schematic illustration of the structure of a flexible Li—S pouch cell, FIG. 6b shows charge/discharge curves and FIG. 6c shows the cycling performance of the Li—S pouch cells, FIG. 6d shows charge/discharge curves of the soft-packaged Li—S cell bent at different angles, and FIG. 6e shows a comparison of the volumetric (W h L_{cell}⁻¹)/gravimetric (W h kg_{cell}⁻¹) energy densities of the reported flexible Li—S batteries. Optical photographs of a flexible Li—S full-cell battery powers LED lights at bent state (FIG. 6f), Electric watch at folded state (FIG. 6g), and a LED screen with single-chip under flat (FIG. 6h) and bent (FIG. 6i) states.

Flexible Li—S full batteries are ideal power sources for flexible and wearable devices. To showcase this capability, the resultant Li—S pouch cells were applied for powering electronic devices. The bent pouch cell can light up 5 red light-emitting diodes (LEDs, the nominal voltage of 2.0-2.2 V), as shown in FIG. 6f. The inset at the bottom-right corner exhibits the same LEDs model when it was lit up in a dark environment. Furthermore, the Li—S pouch cell was connected to an electronic watch and folded. The watch was powered and worked well (FIG. 6g). Finally, a LED screen with a single-chip microprocessor was set up. Because the nominal working voltage of the microprocessor is 5V, while the discharge plateaus of the Li—S battery are 2.3V and 2.1V, and thus three Li—S pouch cells were connected together to achieve the voltage higher than 5V. The LED screen was lighted up when the batteries were flat or bent at an angle of over 90°, showing a clear caption of ‘Flexible Li—S Deakin Uni’, indicating the high energy density and excellent mechanical properties of the obtained flexible Li—S pouch cells. Accordingly, the intriguing flexibility together with superior electrochemical performance endows the lithium-cloth-based Li—S batteries with a great potential for flexible electronic device application.

The inventors have developed a flexible Li—S pouch cell comprising an ultra-stable lithium cloth anode, polysulfone (PSU) functionalised separator and the functional boron nitride/graphene (FBN/G) protected free-standing graphene/sulfur cathode. The lithium cloth anodes are fabricated by storing lithium in the micro/nano porous structures of the functionalised carbon cloth via molten lithium infusion process. The new flexible pouch cells have several advantages: (1) Both lithium cloth anodes and the graphene/sulfur cathodes are free-standing, no additional metallic current collectors are need. All the components possess excellent mechanical flexibility, ensuring good electrochemical performance of the cell when being repeatedly bent or folded. (2) Volume change and dendrites growth of the lithium anodes are confined by the stable and conductive interconnected network of the functionalised carbon fibres. (3) The addition of PSU in the polyethylene separators leads to the improvements on the mechanical performance and thermal stability of the polyethylene separators, further improving the safety of the full cells. (4) Shuttle effect is greatly limited, because of the synergistic effect of the PSU coated separator and the FBN/G interlayer. These lead to excellent performance of the flexible full cells of Li—S batteries. The lifetime of the flexible pouch cells can reach 800 cycles in folded state with the volumetric and gravimetric energy densities of 497 Wh L-land 464 Wh kg⁻¹, respectively. One flexible Li—S pouch cell is capable to power LED lights or an electronic watch, and three connected cells can light a LED screen with a single-chip whose nominal voltage at 5 V both under flat and bent states. This research sheds light on the promising practical applications of Li—S batteries in high energy density flexible energy-storage devices.

### Materials and Methods

Synthesis of lithium cloth: The lithium cloth was prepared via two steps: first, commercial carbon cloth was functionalised with 3D network of MnO₂ nanosheets using a hydrothermal method whereby 1.25 mmol potassium permanganate (KMnO₄) powder and 5 mmol concentrated hydrochloric acid were added into 34 mL deionized water to produce a precursor solution. The obtained solution was transferred into a Teflon-lined autoclave with a capacity of 45 mL, and the carbon cloth was put into the solution. Teflon lined stainless-steel autoclave was heated at 140° C. in an oven for 30 minutes. After heating, the sample was washed and collected. Second, the as-functionalised carbon cloth was placed on the surface of molten Li in an argon-filled glovebox. The functionalised carbon cloth can be easily wetted and filled by molten Li because of the lithiophilicity of MnO₂, forming a stable lithium cloth.

Fabrication of symmetric lithium cloth pouch cells: Symmetric lithium cloth pouch cells with the encapsulation of commercial soft Al-plastic film were assembled in an argon-filled glove box using 2 pieces of lithium clothes and a separator (Celgard 2400). The electrolyte was 1 M LiTFSI in DOL/DME with 1 wt % LiNO₃.

Synthesis of PSU-Celgard separators: Firstly, 2.5 g PSU pellets were added into 7.5 g dimethylformamide (DMF). The solution was then stirred and heated at 80° C. for 10 hours. The obtained solution was casted on a commercial Celgard 2400 separator with a doctor blade and the thickness was adjusted to 200 μm. The separator with PSU coating was transferred into vacuum. After the vacuuming, the PSU on the surface of the separators was wiped away. The obtained separators were washed with water, followed with drying in the oven under 60° C.

Synthesis of free-standing graphene/sulfur cathode with FBN/G interlayers: A mixture consisting of 12 wt. % high porous graphene (Graphene Supermarket, USA), 8 wt. % high surface graphene (Graphene Supermarket, USA), and 80 wt. % sulfur, was heated at 300° C. in an airtight container for 24 h for synthesizing a graphene/sulfur electrode. The free-standing graphene/sulphur cathodes are fabricated via vacuum filtration method. The obtained graphene/sulphur powder were introduced into ethanol saturated with sulphur, and the concertation is 8 g L⁻¹. Vacuum filtration with an anodic alumssinum oxide membrane (AAO, Whatman, with diameter of ˜47 mm and pore size of ˜0.2 μm) as filter was used to yield the free-standing graphene/sulphur cathodes. The as-obtained freestanding cathodes were dried in a vacuum oven at 60° C. for 48 hours.

These electrodes were furthered coated with the FBN/G interlayer. The FBN/G interlayer was prepared by mixing 20 wt % of FBN, 70 wt % of graphene, and 10 wt % polyvinyldenefluoride binder in N-methylpyrrolidinone (Sigma-Aldrich) solution. The slurry was coated onto the surface of graphene/sulfur cathode electrode and dried in an air oven for 24 h at 60° C.

Fabrication of Li—S coin cells: The lithium cloth anodes, PSU-Celgard separators and graphene/S cathode with FBN/G interlayers are used to fabricate the Li—S coin cells. The electrolyte was 1 M LiTFSI in DOL/DME with 1 wt % LiNO₃ and appropriately added according to the mass of the sulfur. The control Li—S coin cells are made with lithium foil anodes, Celgard 2400 separators and graphene/sulfur cathodes.

Fabrication of flexible Li—S pouch cells: The fully flexible Li—S battery cell with the encapsulation of commercial soft Al-plastic film was assembled in an argon-filled glove box using free-standing graphene/sulfur cathodes and lithium cloth anodes. The electrolyte to sulfur (E/S) ratio is 20/1 [mL g⁻¹].

Characterisations: Sample morphologies were examined using a field emission scanning electron microscopy (FESEM, Hitachi s-8600 microscope). D8 Advance X-ray diffractometer (Bruker) was used to conduct X-ray diffraction (XRD) analysis. The samples were covered with Kapton tape on the holder during XRD measurements to avoid direct contact with air. Thermogravimetric Analysis (TGA) was performed on a NETZSCH TG 209F1 Libra (NETZSCH) instrument. The Brunauer-Emmett-Teller (BET) surface area was analyzed using a Tristar II 3020 for the adsorption of nitrogen.

Electrochemical measurements: All the Coin cells and soft-packaged cells were assembled in an Ar-filled glovebox with O₂ and H₂O<1 ppm. The AC impedance of symmetric Li/Li cells (frequency range from 0.1 to 10⁶ Hz at an amplitude of 10 mV) was examined using a Solartron 1255B Frequency Response Analyzer. The galvanostatic cycling test was conducted on a LAND 8-channel battery tester.

### Embodiments

1. A separator for an energy storage device, wherein the separator comprises one or more porous films of Li ion selective permeable material, wherein at least a portion of the pores of the film are associated with a porous sulfur containing polymer, wherein the pores of the sulfur containing polymer are smaller than the pores of the Li ion selective permeable material by at least one 0.5 order of magnitude or greater (a factor of 2 times or greater).

2. The separator of embodiment 1 or embodiment 2, wherein the pores of the film having an average pore size of greater than 100 nm and wherein the average pore size of the sulfur containing polymer is about 50 nm or less, more preferably about 10 nm or less.

3. The separator of embodiment 1 or embodiment 2, wherein the separator comprises one or more microporous films of Li ion selective permeable material and wherein at least a portion of the micrometer pores of the film are associated with a nanoporous sulfur containing polymer.

4. The separator of any one of the preceding embodiments, wherein the sulfur containing polymer is present at about 20 wt % or less, more preferably at about 15 wt % or less, most preferably at about 10 wt % or less.

5. The separator of any one of the preceding embodiments, wherein the sulfur containing polymer has a melting point of 250° C. or greater, more preferably 275° C. or greater, and most preferably still 280° C. or greater.

6. The separator of any one of the preceding embodiments, wherein the sulfur containing polymer is selectively permeable to lithium ions and electrolyte but not to polysulfides.

7. The separator of any one of the preceding embodiments, wherein the pores of the separator are filled with the sulfur containing polymer via a method involved a phase inversion step.

8. The separator of any one of the preceding embodiments, wherein the sulfur containing polymer is present at a mass loading of from about 0.10 mg/cm⁻² to about 0.2 mg/cm⁻².

9. The separator of any one of the preceding embodiments, wherein the sulfur containing polymer is a sulfonylated polymer, preferably, a functionalised or unfunctionalised aromatic polysulfone, preferably a polyarylethersulfone (PAES) for example, polysulfone.

10. The separator of any one of the preceding embodiments, wherein the material of the film comprises an organic polymer, particularly a polyolefin polymer, which may be functionalised or unfunctionalised.

11. The separator of any one of the preceding embodiments, wherein the separator is flexible.

12. The separator of any one of the preceding embodiments, wherein the separator has an ionic conductivity of greater than 6.87 mS cm⁻¹ at 25° C.

13. A method of preparing a separator for an energy storage device comprising the steps of:
(i) providing a porous separator for the energy storage device comprising one or more microporous films of at least one Li ion selective permeable material;
(ii) forming a sulfur containing polymer functionalised film by filing the micropores of the film of at least one Li ion selective permeable material with at least one sulfur containing polymer;
(ii) introducing nanopores into the sulfur containing polymer.

14. The method of embodiment 13, wherein the step of forming the sulfur containing polymer functionalised film involves proving a solution of the sulfur containing polymer in a solvent to the surface film of at least one Li ion selective permeable material, for example, by solvent casting and removing the solvent to form the sulfur containing polymer functionalised film and wiping or brushing excess polymer off the surface of the film to removes excess sulfur containing polymer which is not in the pores, from the separator.

15. The method of embodiments 13 or 14, wherein the step of introducing nanopores into the sulfur containing polymer involves treating the functionalised film to a phase inversion wetting process, whereby solvent/non-solvent exchange process results at the phase interface in the formation of the nanoporous structure in the sulfur containing polymer component in the film's pores.

16. A lithium metal anode for an energy storage device comprising a flexible electrically conducting fabric having an interconnected network of fibres, wherein each fibre is functionalised with one or more lithiophilic materials, whereby lithium metal is insertable, storable and removeable from gaps or spaces between the functionalised fibres.

17. The lithium metal anode of embodiments 16, wherein the lithiophilic materials form a network of lithiophilic material having a hierarchical nanostructure, preferably in nanosheet or nanoflake form.

18. The lithium metal anode of embodiments 16 or embodiments 17, wherein lithiophilic material comprises MnO₂, SnO₂, ZnO, Co₃O₄, preferably, hierarchical MnO₂ nanosheets.

19. The lithium metal anode of embodiment 16 or embodiment 17, wherein the fabric of the lithium metal anode comprises a porous 3D microstructure provided by a network of interconnected, preferably interlaced or interwoven fibres, and a nanostructure imparted by the lithiophilic material on the fabric's fibres.

20. The lithium metal anode of any one of embodiments 16 to 19, wherein the fabric has an electrical resistivity is 1.4×10⁻³ Ω·cm.

21. The lithium metal anode of any one of embodiments 16 to 20, wherein the fabric is carbon cloth.

22. The lithium metal anode of any one of embodiments 16 to 21, wherein the lithium metal is present at a loading of from about 2 mg cm⁻² to about 10 mg cm⁻².

23. A method of preparing a lithium metal anode for an electrochemical cell comprising the steps of:
(i) functionalising a flexible electrically conducting fabric with one or more lithiophilic materials;
(ii) associating the functionalised fabric with lithium metal.

24. The method of embodiment 23, wherein the step of functionalisation the fabric with the lithiophilic materials involves a hydrothermal method, using for example, potassium permanganate powder, concentrated hydrochloric acid and deionized water.

25. The method of embodiment 23 or embodiment 24, wherein the step of associating the functionalised fabric with lithium metal involves infusing the fabric with lithium, preferably, molten lithium metal.

26. The method of any one of embodiments 23 to 25, further comprising the step of adjusting the infusion time to control the amount of lithium associated with the fabric.

27. An energy storage device comprising: a lithium metal anode; a cathode comprising sulfur and one or more electrically conducting substances; and a separator according to any one of embodiments 1 to 12 positioned between the anode and the cathode.

28. An energy storage device comprising a lithium metal anode according to any one of embodiments 16 to 22; a cathode comprising sulfur and one or more electrically conducting substances; and a separator positioned between the anode and the cathode.

29. An energy storage device comprising a lithium metal anode according to any one of embodiments 16 to 22; a cathode comprising sulfur and one or more electrically conducting substances; and a separator according to any one of embodiments 1 to 12 positioned between the anode and the cathode.

30. The energy storage device of any one of embodiments 27 to 29, wherein the cathode is protected by at least one FBN/G interlayer.

31. The energy storage device of any one of embodiments 27 to 30, which is a flexible energy storage device, whereby one or more of the anode, cathode and separator are flexible.

32. The energy storage device of any one of embodiments 27 to 31, wherein one or more of the anode and the cathode are free-standing.

33. The energy storage device of any one of embodiments 27 to 32, wherein the anode, cathode and separator are encased in a moisture resistant flexible housing.

34. The energy storage device of any one of embodiments 27 to 33, further comprising electrolyte.

35. The energy storage device of any one of embodiments 27 to 34, wherein on experiencing a manual deforming force, such as a crease fold, that is a 90° fold, or an edge to edge fold, for example, a 180° fold, under the fabric's own weight, retains its electrical resistance to within ≤50% of its original resistivity value.

36. The energy storage device of any one of embodiments 27 to 35, wherein the device retains up to 60% of the initial capacity after at least 800 cycles at a current density of 0.5 C.

37. The energy storage device of any one of embodiments 27 to 35, exhibiting a volumetric energy density of at least about 100 Wh L⁻¹, more preferably at least about 300 Wh L⁻¹, most preferably still at least about 500 Wh L⁻¹, after 800 cycles in a folded state meaning a bend angle of up to and including 180°.

38. The energy storage device of any one of embodiments 27 to 35, exhibiting a gravimetric energy density of at least about 75 Wh Kg⁻¹, more preferably at least about 250 Wh Kg⁻¹, most preferably at least about 470 Wh Kg⁻¹, after 800 cycles in a folded state meaning a bend angle of up to and including 180°.

39. Use of a sulfur containing polymer, preferably polysulfone, as a pore filler in a porous film of a Li ion selective permeable material.

40. Use of a flexible separator in an energy storage device, particularly a flexible lithium sulfur battery, wherein the separator comprises one or more porous films of Li ion selective permeable material wherein at least a portion of the pores of the film are associated with a sulfur containing polymer.

41. Use of a flexible lithium metal anode comprising an electrically conducting fabric functionalized with one or more lithiophilic materials in an energy storage device, particularly a flexible lithium sulfur battery.

42. An electronic device comprising the separator according to any one of embodiments 1 to 12, the lithium metal anode according to any one of embodiments 16 to 26, and/or the energy storage device of any one of embodiments 27 to 38.

43. The electronic device of embodiment 42, in the form of a wearable device, such as electronic watch, and LED or an LED screen.

44. A flexible energy storage device comprising: a flexible lithium metal anode for an energy storage device comprising an electrically conducting fabric functionalised with a 3D hierarchical MnO₂ nanosheet lithiophilic material; a flexible graphene/sulfur cathode protected by a FBN/G interlayer; and a flexible separator for an energy storage device, wherein the separator comprises one or more microporous films of Li ion selective permeable polyolefin material wherein at least a portion of the pores of the film are associated with nanoporous polysulfone polymer positioned between the anode and the cathode.

1. An energy storage device comprising:
a lithium metal anode;
a cathode comprising sulfur and one or more electrically conducting substances; and
a porous separator positioned between the anode and the cathode,
wherein the porous separator comprises one or more porous films of Li ion selective permeable material, wherein at least a portion of pores of each film of Li ion selective permeable material are filled with a porous sulfur containing polymer, wherein the pores of the sulfur containing polymer are smaller than pores of the Li ion selective permeable material by a factor of 2 times or greater such that the sulfur containing polymer is selectively permeable to lithium ions and electrolyte but not to polysulfides, and wherein the sulfur containing polymer is not present on surfaces of the one or more porous films.

2. The energy storage device of claim 1, wherein the pores of each film of Li ion selective permeable material have an average pore size of greater than 100 nm and wherein the average pore size of the sulfur containing polymer is about 50 nm or less.

3. The energy storage device of claim 1, wherein the sulfur containing polymer is present at about 20 wt % or less.

4. The energy storage device of claim 1, wherein the sulfur containing polymer has a melting point of 250° C. or greater.

5. The energy storage device of claim 1, wherein the sulfur containing polymer is present at a mass loading of from about 0.10 mg/cm⁻² to about 0.2 mg/cm⁻².

6. The energy storage device of claim 1, wherein the sulfur containing polymer is a sulfonylated polymer.

7. The energy storage device of claim 6, wherein the sulfur containing polymer is a functionalized or unfunctionalized aromatic polysulfone.

8. The energy storage device of claim 1, wherein the film of Li ion selective permeable material comprises an organic polymer.

9. The energy storage device of claim 8, wherein the organic polymer is a functionalized or unfunctionalized polyolefin polymer.

10. The energy storage device of claim 1, wherein the separator is flexible.

11. The energy storage device of claim 1, which is a flexible energy storage device, whereby the anode, cathode and separator are flexible.

12. The energy storage device of claim 1, wherein the cathode is protected by at least one functionalised boron nitride nanosheets/graphene (FB N/G) interlayer.

13. The energy storage device of claim 1, wherein the lithium metal anode comprises:
a flexible electrically conducting fabric having an interconnected network of fibres, wherein each fibre is functionalised with a lithiophilic material,
wherein the lithiophilic material has a hierarchical nanostructure to increase surface area of the fabric, and
wherein the anode further comprises lithium metal,
whereby the lithium metal is insertable, storable and removeable from spaces between the functionalised fibres.

14. The energy storage device of claim 13, wherein the hierarchical nanostructure comprises nanosheets and/or nanoflakes.

15. The energy storage device of claim 13, wherein the lithiophilic material comprises MnO₂, SnO₂, ZnO, or Co₃O₄.

16. The energy storage device of claim 13, wherein the lithiophilic material comprises MnO₂ nanosheets and/or MnO₂ nanoflakes.

17. The energy storage device of claim 13, wherein the fabric of the lithium metal anode comprises a porous 3D microstructure provided by interlaced or interwoven fibres and a nanostructure imparted by the lithiophilic material on the fabric fibres.

18. The energy storage device of claim 13, wherein the fabric is carbon cloth.

19. The energy storage device of claim 13, wherein the lithium metal is present at a loading of from about 2 mg cm 2 to about 10 mg cm⁻².

20. The energy storage device of claim 1, wherein
the lithium metal anode is a flexible electrically conducting fabric functionalized with a 3D hierarchical MnO₂ nanosheet lithiophilic material;
the cathode is a flexible graphene/sulfur cathode protected by a functionalised boron nitride nanosheets/graphene (FBN/G) interlayer; and
the porous separator is flexible.
